(19) United States
(12) Patent Application Publication
(10) Pub. No.: US 2017/0344519 A1
(43) Pub. Date: Nov. 30, 2017

(54) MULTI-LEVEL FONT SUBSTITUTION CONTROL

(71) Applicant: Microsoft Technology Licensing, LLC, Redmond, WA (US)

(72) Inventors: Cameron A. Scott, Seattle, WA (US); Voraluk (Kay) Tosukhowong, Redmond, WA (US)

(73) Assignee: Microsoft Technology licensing, LLC, Redmond, WA (US)

(21) Appl. No.: 15/166,845

(22) Filed: May 27, 2016

(51) Int. Cl. G06F 17/21; G06F 3/0484

(52) U.S. Cl. CPC G06F 17/214; G06F 3/0484

(57) ABSTRACT

When a requested font is unavailable, a multi-level font substitution system performs multi-level font substitution processing. It determines whether a highest tier substitute font is available and if not, whether an intermediate tier substitute font is available and if not, whether a lowest tier substitute font is available. Content is rendered using the best available substitute font that was identified in the highest processing tier of the multi-level font substitution processing.

### BACKGROUND

Computer systems are currently in wide use. Many computer systems render content for consumption by a user. The content can often be alphanumeric content in which the characters are rendered using a font.

Fonts are often described or defined in a font file. For example, each different font may have a different font file that is accessed by a rendering system in order to render alphanumeric content using that font. It can happen, however, that a particular device or computing system that is rendering the content may not have a font (or font file), or does not have access to the font (or font file), that was ascribed to the content by the author. Some systems have attempted to address this issue using font substitution.

Font substitution occurs when a document or entity to be rendered is associated with a font file that is not available on a device or platform that is attempting to render the document or entity. A substitute font is provided to ensure that the text (or other content) can be rendered and consumed. However, the substitute font is not guaranteed to match the original font for the document (or the requested font) and so document fidelity may be compromised. For instance, substitute fonts and requested fonts may not match with respect to font metrics. Font metrics may, for instance, define the height and width and other information about a specified font, and specific character glyphs in that font, among other things. The font metrics basically define how the font looks, when rendered.

The discussion above is merely provided for general background information and is not intended to be used as an aid in determining the scope of the claimed subject matter.

### SUMMARY

When a requested font is unavailable, a multi-level font substitution system performs multi-level font substitution processing. It determines whether a highest tier substitute font is available and if not, whether an intermediate tier substitute font is available and if not, whether a lowest tier substitute font is available. Content is rendered using the first available substitute font that was identified in the font substitution processing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIG. 2 is a block diagram showing one example of a font substitution system, in more detail.

FIG. 3 is a flow diagram illustrating the operation of the font substitution system in performing font substitution processing.

FIG. 4 is a block diagram of one example of a font substitution table generation system.

FIG. 5 shows the architecture illustrated in FIG. 1, deployed in a cloud computing architecture.

FIGS. 6-8 show examples of mobile devices that can be used in the architectures shown in the previous figures.

FIG. 9 is a block diagram of one example of a computing environment that can be used in the architectures shown in the previous figures.

### DETAILED DESCRIPTION

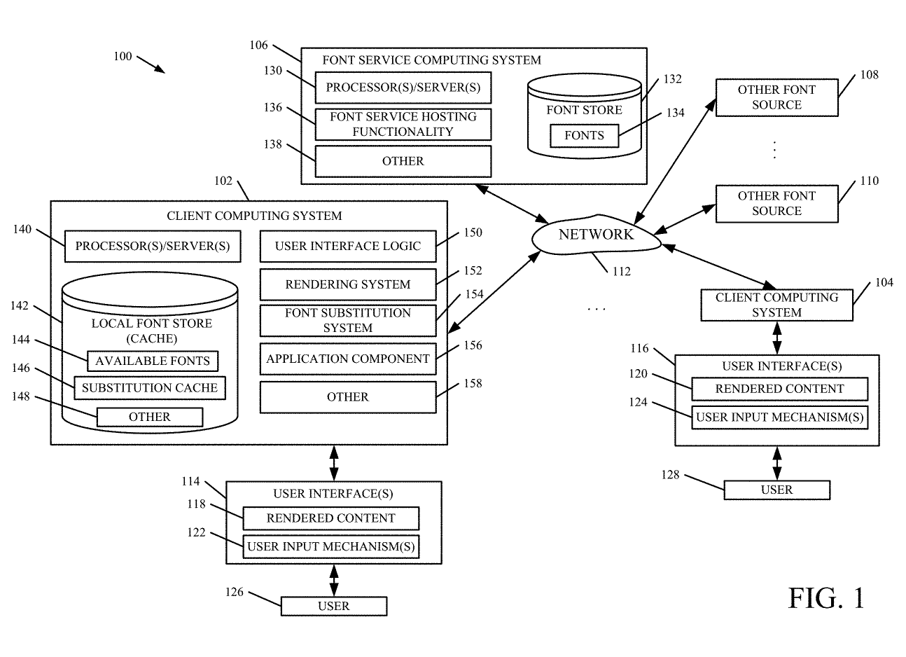

FIG. 1 is a block diagram of one example of a computer system architecture 100. Architecture 100 illustratively includes a set of client computing systems 102-104, font service computing system 106 and a variety of font sources 108-110. These items are all illustratively connected by network 112. Network 112 can be a wide variety of different types of networks, such as a local area network, a wide area network, a near field communication network, or others.

In the example illustrated in FIG. 1, client computing systems 102-104 illustratively generate user interfaces 114-116. Each of the user interfaces illustratively renders content 118-120 with user input mechanisms 122-124 for interaction by users 126-128. Users 126-128 illustratively interact with user input mechanisms 122-124, in order to control and manipulate client computing systems 102-104, respectively.

Font service computing system 106 illustratively includes one or more processors or servers 130, font store 132 that stores a variety of different fonts 134, and font service hosting functionality 136. It can include other items 138 as well. Font service hosting functionality 136 can obtain fonts 134 from a variety of different font sources 108-110 and store them in font store 132. It can obtain fonts 134 in other ways as well. When a client computing system 102-104 accesses font service computing system 106, it may illustratively request one of the fonts 134 that can be used in rendering content 118-120 for users 126-128. In response, font service hosting functionality 136 illustratively retrieves and downloads the requested font 134 from font store 132 to the requesting client system 102-104.

In the example shown in FIG. 1, client computing system 102 also illustratively includes one or more processors or servers 140, local font store 142 (that stores available fonts 144, a substitution cache 146, and it can store other items 148), user interface logic 150, rendering system 152, font substitution system 154 and application component 156. System 102 can include a wide variety of other items 158 as well.

Application component 156 illustratively runs one or more applications that are launched by user 126 to render content 118. The content 118 may be associated with a particular font. If that font is available in the available fonts 144, or, in some cases, if it is available from font service computing system 106, then application component 156 retrieves the requested font and uses user interface logic 150 and rendering system 152 to render the content 118 using the requested font. However, when the requested font is unavailable, application component 156 uses font substitution system 154 to find an available font 144 (or a font that is available from font service computing system 106) to use as a substitution.

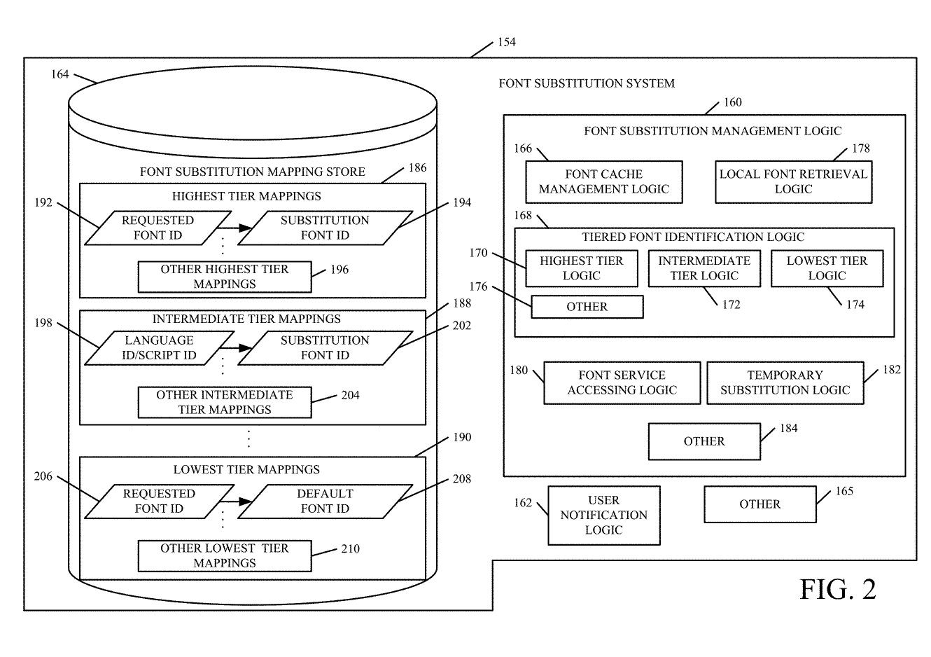

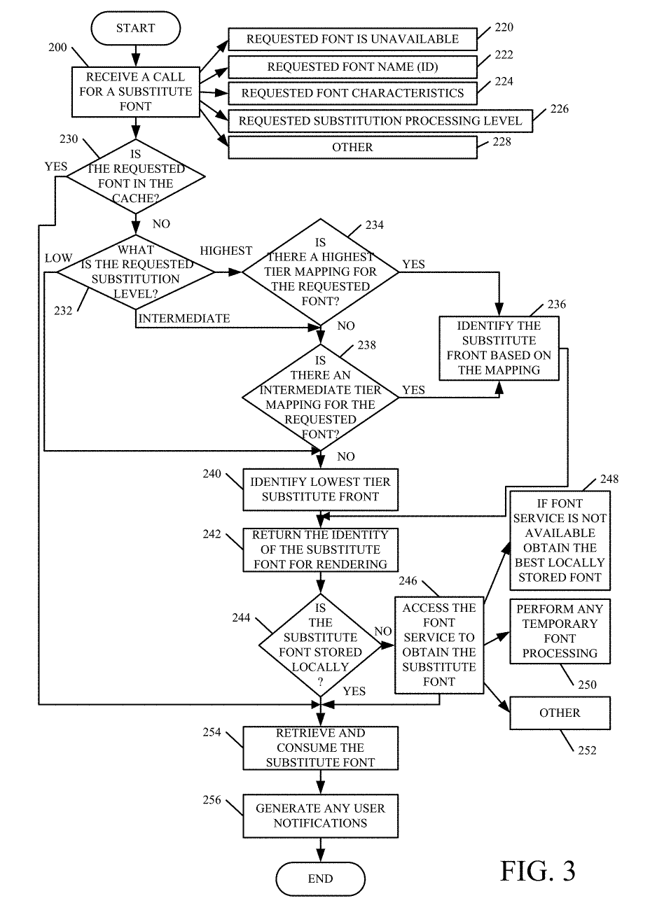

In one example, font substitution system 154 performs a multi-tier substitution process in order to locate and provide the substitute font. This is described in greater detail below with respect to FIGS. 2 and 3.

Rendering system 152 is used to render the rendered content 118 using either the requested font, or the substitute font. User interface logic 150 illustratively detects user inputs through user input mechanisms 122 and provides an indication of those user inputs to application component 156 or other items in client computing system 102, that are configured to receive and respond to such inputs.

FIG. 2 is a block diagram of one example of font substitution system 154, in more detail. While FIG. 1 shows that the client computing systems 102 and 104 can have font substitution system 154, it will be noted that font substitution system 154 may be located on font service computing system 106 instead. In another example, both font service computing system 106 and client computing systems 102-104 have font substitution systems 154. All of these architectures are contemplated herein. However, the present example will proceed with respect to font substitution system 154 residing on the client computing systems 102-104 only.

In the example shown in FIG. 2, font substitution system 154 illustratively includes font substitution management logic 160, user notification logic 162, font substitution mapping store 164, and it can include other items 165. Management logic 160 illustratively includes font cache management logic 166, tiered font identification logic 168 (which, itself, illustratively includes highest tier logic 170, one or more sets of intermediate tier logic 172, lowest tier logic 174, and it can include other items 176), local font retrieval logic 178, font service accessing logic 180, temporary substitution logic 182, and it can include other items 184. Font substitution mapping store, itself, illustratively includes a set of highest tier mappings 186, one or more sets of intermediate tier mappings 188, and lowest tier mappings 190. Each of the highest tier mappings 186 map a requested font identifier (font ID) 192 to a substitution font identifier (substitution font ID) 194. While one mapping (e.g., one requested font ID 192 mapped to a substitution font ID 194) is illustrated, highest tier mappings 186 illustratively include a plurality of other highest tier mappings 196 as well. The mappings map a requested font (that is illustratively unavailable when rendering the associated content) identified by requested font ID 192 to a best substitution font 194 for the requested font, identified by substitution front ID 194.

The highest tier mappings 186 can be generated in a wide variety of different ways. For instance, they can be generated using telemetry data that is collected on client computing systems 102-104. This data may indicate, for instance, which fonts are most often requested, which substitute fonts are most often selected by users (when they are given the opportunity to select a substitute font), any user feedback with respect to substitute fonts, any layout or other rendering errors that are generated when substituting one font for another, indications of which fonts are best on which devices, platforms, etc., or a wide variety of other telemetry data. In addition, the highest tier mappings 186 can be generated using expert data. Experts may examine font characteristics or a wide variety of other layout or rendering scenarios and identify which substitute fonts most closely match which requested fonts, when being laid out on a display device at a client computing system 102. The mappings 186 may consider the type of device that the content is being rendered on (e.g., a small screen device such as a smart phone, or a larger screen device such as a tablet, a laptop, etc.), they may account for the different platforms, operating systems, etc., of the different devices and they may account for a wide variety of other factors as well. Highest tier mappings 186 illustratively map the requested fonts to their best substitute fonts, in a given scenario, using the requested font ID 192 and the substitution font ID 194. The IDs may simply be font names or other font identifiers.

The requested font may have a language identifier or script identifier associated with it, or those identifiers may be obtained from the content to be rendered or the device rendering it. Those identifiers identify the particular language or script that the content will be rendered in. Intermediate tier mappings 188 may map from those IDs to a substitute font ID.

As shown in FIG. 2, intermediate tier mappings 188 may be based on the language ID. For instance, there may be a best substitute font for each individual language, under various circumstances. By way of example, if the rendered content is to be rendered in the English language and the client device is a smart phone, then one substitute font may be best. However, if the content is to be rendered in Italian and the client device is a laptop computer, then another substitute font may be best.

Similarly, another set of intermediate mappings 188 may be based on the script of the requested font (or content to be rendered). If the rendered content is to be rendered in one particular script, first substitute font may be best, while if the rendered content is in a different script, another substitute font may be best. The script differs from the language in that the script refers to a type of character being used, while the language refers to a particular spoken language. By way of example, the letters in both the English and Italian languages are, by and large, common and are in the Latin script. On the other hand, the Bulgarian and Russian languages are in the Cyrillic script, etc. Thus, while the script is the same, the languages are different, and an intermediate set of mappings 188 can be configured to map from a given script to a particular substitution font.

Yet another set of intermediate mappings 188 may be based on what is referred to as PANOSE information. This information generally provides a classification system in the font community that describes or characterizes a font. The PANOSE information may include such information as font weight, slope, style, width, and a wide variety of other font characteristics. A set of intermediate mappings 188 may map from a set of font characteristics of a requested font ID to a particular substitution front for that set of font characterization.

These are all examples of intermediate tier mappings 188. In FIG. 2, the intermediate tier mappings are shown mapping from a language or script ID 198 to a substitution font ID 202. While one such mapping is illustrated, other intermediate tier mappings (or sets of intermediate tier mappings) 204 may be included as well.

The lowest tier mappings 190 may illustratively be used either when requested, or when no highest tier mappings 186 or intermediate tier mappings 188 can be located for the requested font. The lowest tier mappings illustratively include the requested font ID 206 mapped to a default font ID 208. There can be a lowest tier mapping for a variety of different fonts, and these lowest tier mappings are represented by block 210 in FIG. 2.

In one example, the different substitute fonts is identified by the different tiers 186, 188 and 190, may provide different fidelity in the rendered content. If the substitute font is identified at a lower tier, the fidelity of the rendered content may be more compromised than if the substitute font is identified at a higher tier. For instance, if a document is rendered using a substitute font identified using a highest tier mapping 186, the fidelity of the rendered content may not be impacted at all, or may be only slightly impacted. On the other hand, if it is rendered using a substitute font identified from lowest tier mappings 190, it may be that the fidelity is highly affected. In such an instance, it may be that some characters are not rendered, but instead placeholders (such as empty boxes) are rendered instead.

A number of items in font substitution management logic 160 will now be described, by way of overview, before describing them in more detail. Font cache management logic 166 illustratively manages the fonts stored in substitution cache 146 (shown in FIG. 1). Thus, if a requested font ID has been recently submitted for substitution, logic 166 determines whether the font is already located in the substitution cache 146 and, if so, returns the font from that cache.

If not, then tiered font identification logic 168 uses highest tier logic 170 to first determine whether a substitute font can be identified from the highest tier mappings 186. If not, intermediate tier logic 172 determines whether one can be identified from intermediate tier mappings 188, and if not, lowest tier logic 174 identifies a substitute font using lowest tier mappings 190.

Once the substitute font is identified, local font retrieval logic 178 retrieves the fonts from local font store 142, if it is available. Font service accessing logic 180 accesses font service computing system 106 (when it has access to that service), and when the substitute font is not available from local font store 142. It requests font service computing system 106 to return the substitute font, and downloads it.

Because downloading a font can take a relatively large amount of time, temporary substitution logic 182 can use a locally available font to temporarily render the content 118, while the best matching font is downloaded from font service computing system 106. In doing so, temporary substitution logic 182 may use user notification logic 166. The temporary substitution font may be a second best matching or a next best matching font that is locally available. Then, once the best matching font is downloaded, the rendered content can be updated so the content is rendered using the downloaded font.

User notification logic 162 illustratively generates a variety of different notifications for user 126, related to font substitution. For instance, when temporary substitution logic 182 is temporarily rendering the content using a next best (but locally available) substitution font, notification logic 162 may generate a notification to the user indicating this. Similarly, when the content is being rendered using a substitution font identified from lowest tier mappings 190, user notification logic 162 may indicate to the user that the requested font is unavailable and the fidelity of the document is being greatly affected because of that. A wide variety of other user notifications can be generated as well.

FIG. 3 is a flow diagram illustrating the operation of one example of the architecture shown in FIG. 1 and font substitution system 154 shown in FIG. 2, in providing a substitute font for rendering content 118, when the original or requested font is unavailable. In the example illustrated, user 126 has requested application component 156 to render content (or content can be rendered automatically or in another way). At that point, application component 156 identifies a font associated with the content to be rendered (e.g., the requested font) and determines that the font is not available. Where a client computing system 102 is operating offline, application component 156 determines that the font is not available in the local font store 142. Where client computing system 102 has access to font service computing system 106, application component 156 may also determine that the requested font is not available from font service computing system 106 as well. At some point, application component 156 calls font substitution system 154 for a substitute font. Receiving a call for a substitute font because the requested font is unavailable is indicated by blocks 200 and 220 in FIG. 3.

In the call, the application component 156 can provide font substitution system 154 with the requested font name (or other font identifier) and it can provide the characteristics of the requested font as well. This is indicated by blocks 222 and 224.

In one example, the application component 156 can also indicate a requested substitution processing level that it wishes font substitution system 154 to engage in. For instance, the application component 156 may simply wish font substitution system 154 to default to the lowest tier mappings 190, in the event that a requested font is unavailable. This may be done for a variety of different reasons. In addition, it may be that the application component requests font substitution system 154 to begin with the intermediate mappings 188, rather than with the highest tier mappings 186. Alternatively, application component 156 may request that font substitution system 154 engage in the full, multi-tier font substitution processing, beginning with the highest tier mappings 186 and continuing on until it finds a substitute font. Providing the requested font substitution processing level is indicated by block 226 in FIG. 3. The call to obtain a substitute font may include other things, and it may be done in other ways as well, and this is indicated by block 228.

Upon receiving a call for a substitute font, font cache management logic 166 first determines whether a response to a call for a substitute font, identifying the same requested font, has been recently received, in which case that the substitute font is likely already stored in cache 146. If so, the substitute font is retrieved from the substitution cache 146 and returned to the application, for consumption. This is indicated by blocks 230 and 254 in FIG. 3.

Assuming that the substitute font is not in cache, then tiered font identification logic 168 determines whether the application component 156 has requested a specific level of font substitution processing as discussed above with respect to block 226. Regardless of which level of substitution font processing is to be used, font substitution management logic 160 obtains a substitution font identifier that identifies the particular substitution font that is to be returned to the application component.

In one example, if the application component 156 has not specified a level of font substitution processing, then processing defaults to the highest level of processing. This is an example only. If the highest level of processing is to be performed (e.g., it is either expressly requested, or defaulted to), then highest tier logic 170 attempts to identify a highest tier mapping 186 that maps the requested font handed in with the call for a substitute font, to a substitution font. In doing so, highest tier logic 170 attempts to match the requested font identifier against the requested font ID 192 in the highest tier mappings 186. If a matching mapping is found, then highest tier mapping logic 170 identifies the substitute font, by following the matched mapping to the substitution font ID 194 in the mapping. This is indicated by blocks 234 and 236 in FIG. 3.

If, at block 234, highest tier logic 170 determines that none of the highest tier mappings 186 match the requested font ID, then intermediate tier logic 172 determines whether there is an intermediate tier mapping that matches the requested font. This is indicated by block 238. As discussed above, there may be multiple sets of intermediate tier mappings. The first set of intermediate tier mappings may be based on the language of the requested font or of the content being rendered or the rendering device. For instance, if the content is to be rendered in the English language, then one of the intermediate tier mappings may map from the English language (using language identifier 198) to the best substitution font for that language (identified by substitution font ID 202). A set of intermediate tier mappings 188 may also be examined, which map from a script identifier to a substitution font identifier. Further, intermediate tier mappings 188 may be examined, which map from font characteristics to a substitution font identifier. All of these, and other intermediate mappings, are contemplated herein. If the requested font matches any of the intermediate tier mappings 188, then the matched intermediate tier mapping is identified, and logic 172 follows the matched mapping to the substitution font ID 202 to identify the substitute font that is to be returned to the application component 156.

If intermediate tier logic 172 does not find any matching intermediate tier mappings 188, then lowest tier logic 174 identifies a lowest tier substitute font that will be returned. This is indicated by block 240 in FIG. 3. The lowest tier logic 174 may simply return a default font, or it may access lowest tier mappings 190 that map from the requested font ID (or some characteristic of the requested font) 206 to a default font ID (or other lowest tier font ID) 208.

Regardless of whether tiered font identification logic 168 identifies the substitute font from a highest tier mapping 186, an intermediate tier mapping 188, or using lowest tier processing, the identity of the substitute font is obtained so that the substitute font can be loaded and used in rendering the content. Returning the identity of the substitute font is indicated by block 242.

Once the identity of the substitute font is known, local font retrieval logic 178 determines whether the substitute font is stored locally in local font store 142. This is indicated by block 244 in FIG. 3. If so, local font retrieval logic 178 retrieves it and provides it to application component 156 for consumption in rendering the content. This is indicated by block 254.

However, if, at block 244, local font retrieval logic 178 determines that the substitute font is not stored locally, then it indicates this to font service accessing logic 180 which accesses font service computing system 106 in order to obtain the substitute font. This is indicated by block 246. In one example, font service accessing logic 180, while it is obtaining the substitute font from font service computing system 106, uses temporary substitution logic 182 to obtain the next best substitute font that was identified by font substitution management logic 160, and that is stored locally in local font store 142. Temporary substitution logic 182 provides it, as a temporary substitution font, to application component 156. Temporary substitution logic 182 does this until font service accessing logic 180 has downloaded the substitute font from font service computing system 106, at which point temporary substitution logic 188 can provide the final substitution font to application component 156. Obtaining a next best locally stored font, while downloading the substitution font from font service computing system 106, is indicated by block 248. Performing the temporary font processing (e.g., providing the temporary substitute font to the application component 156 and then providing the final substitution font, once it is downloaded) is indicated by block 250. Obtaining the substitute font from the font service computing system 106 can be performed in other ways as well, and this is indicated by block 252.

Prior to, or during, consumption of the substitute font by application component 156, user notification logic 162 can generate any desired user notifications for the user viewing content 118. For instance, if the substitute font is identified by lowest tier logic 174, then user notification logic 162 can generate a notification indicating that the fidelity of the rendered content may be highly impacted because the requested font is not available and a low tier substitute font is being used. In addition, if temporary font processing is being performed by temporary substitution logic 182, the user notification logic 162 can generate a notification to the user indicating that the content is being rendered using a temporary font, while the best font is downloaded. Also, once the best font is being downloaded, a user notification can be generated, with a user actuatable display element, that allows the user to update the rendered content, using the now-downloaded substitution font, by actuating the display element. This gives the user the choice of whether to refresh the display using the now-downloaded font, or to simply maintain the temporary substitution font, in rendering the content. User notification logic 162 can generate a wide variety of other notifications as well, related to the font substitution processing described herein. Generating any user notifications is indicated by block 256 in FIG. 3.

It should also be specifically noted that, as is mentioned above, the font substitution mappings can also account for characteristics of the rendering device or the rendering system. For instance, a particular substitute font may be the best substitute for a particular requested font on a smart phone, but not on a desktop. This may be because the display real estate is larger on the desktop than on the smart phone. Thus, there may be different sets of font substitution mappings that account for different characteristics of the rendering device or the rendering system. There may be different sets of font substitution mappings for the platform (e.g., a smart phone, a tablet, a laptop, a desktop, a larger screen device, etc.) of the rendering device, for the operating system or other software characteristics of the rendering device, for other hardware characteristics of the rendering device (such as the particular graphics processor being used, etc.) or for other reasons. Those described herein are described for the sake of example only.

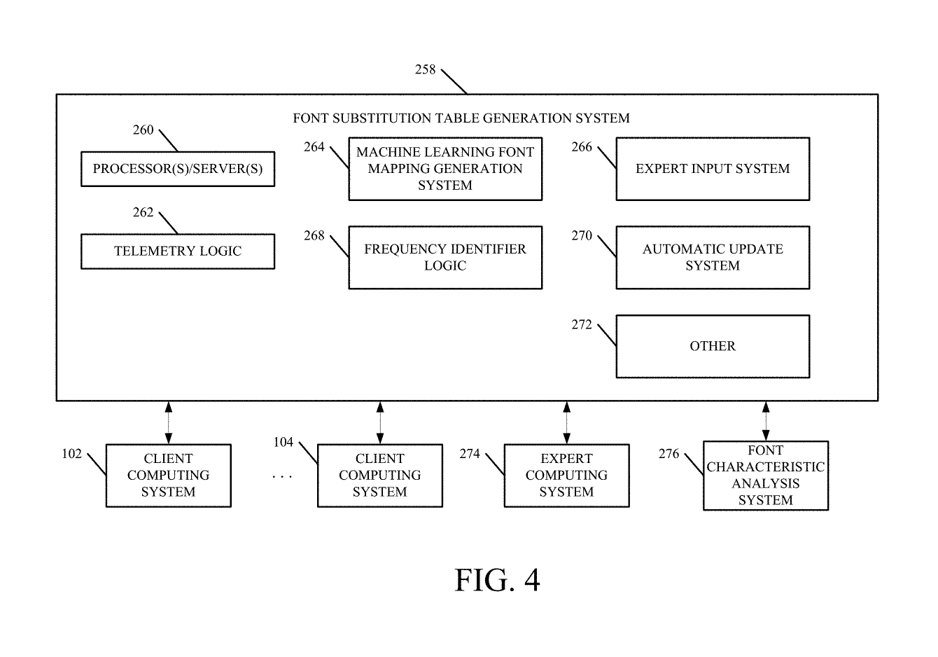

FIG. 4 is a block diagram of one example of a font substitution table generation system 258 that can be used to generate the various mappings in font substitution mapping store 164. Font substitution table generation system 258 illustratively includes one or more processors or servers 260, telemetry logic 262, machine learning font mapping generation system 264, expert input system 266, frequency identifier logic 268, automatic update system 270, and it can include a wide variety of other items 272 as well. FIG. 4 shows that expert computing system 274 is coupled to font substitution table generation system 258, as is font characteristic analysis system 276 and the client computing systems 102-104.

In one example, telemetry logic 262 obtains information from client computing systems 102-104, and it may have client components on those systems that it interacts with as well. Telemetry logic 262 illustratively obtains telemetry information from the client computing systems that may bear upon which substitution fonts should be used for various requested fonts. For instance, telemetry logic 262 may obtain information indicating that users of client computing systems 102-104 consistently select one font over others, when asked to identify a preferred substitute font. It may also obtain information indicative of which fonts are often requested by systems 102-104, to render content. It may obtain feedback information from users or from the systems 102-104, themselves, indicative of different types of content that cannot be adequately rendered (e.g., when errors are seen) with different fonts. It may obtain information indicative of the fidelity of content when it is rendered using a particular substitute font, for a particular requested font. All of this information can be gathered by telemetry logic 262.

In addition, frequency identifier logic 268 can identify the frequency with which certain things occur, such as the frequency with which a particular substitute font is substituted for a particular requested font. It can identify the frequency with which content requests a given requested font, or a wide variety of other frequency information.

Expert computing system 274 can generate user interface displays with user input mechanisms that allow experts to provide information to expert input system 266 indicative of which particular substitute fonts are best for which particular requested fonts. In addition, font characteristic analysis system 276 can analyze the characteristics of a plurality of different fonts and provide an indication as to which particular fonts will be the best substitute fonts for other fonts, under various circumstances, based on these characteristics. For instance, it may compare the characteristics of the different fonts to see which have the closest characteristics. It can perform font characteristic analysis in other ways as well.

All of this information is illustratively provided to machine learning font mapping generation system 264 which continuously learns from the inputs and generates the font substitution mappings stored in store 164. As discussed above, it will be noted that different mappings can be generated for different platforms. For instance, if the rendered content is being rendered on a smart phone with a first operating system, it may be that one substitution font is the best and therefore a mapping is generated to return that substitution font, for that smartphone and operating system. However, if the content is being rendered on a tablet computer or a laptop computer or a desktop computer, or even a larger screen device, or using a different operating system, it may be that the substitution fonts that is best under those circumstances is different. Thus, machine learning system 264 may generate different sets of mappings, for different platforms, for different operating systems, for different rendering hardware or software, for different characteristics of the fonts or for other characteristics.

Automatic update system 270 may illustratively be coupled to font substitution system 154 (whether it is located on client computing systems 102-104 or in font service computing system 106, or in both places), to intermittently update the mappings in font substitution mapping store 164, as machine learning system 264 continues to learn, and update or generate new substitution mappings. By way of example, it may be that, at one point in time, a particular substitute font is not widely used. Therefore, it may initially be identified as a substitution font in one of the intermediate tier mappings 188. However, it may be that over time, machine learning system 264 identifies that that particular font is being more widely adopted, and is therefore being used more often. Therefore, it may be upgraded to a substitution font used in one of the highest tier mappings 186. This is only one example of how machine learning system 264 may learn over time and use automatic update system 270 to update the font substitution mappings in font substitution mapping store 164.

It can thus be seen that the present font substitution processing greatly enhances the operation of the computing system itself. It allows the computing system to render content with much higher fidelity than some prior systems. In addition, it greatly improves the accuracy of the rendering system in rendering the content. Because the rendering system can receive a substitution font (when the requested font is unavailable) that is very close to the requested font, the accuracy and fidelity with which the rendering system can render the content is greatly improved. In addition, this greatly enhances the user experience. The user sees that the appearance of the rendered content is substantially the same, regardless of the requested font, and regardless of the particular platform, etc.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

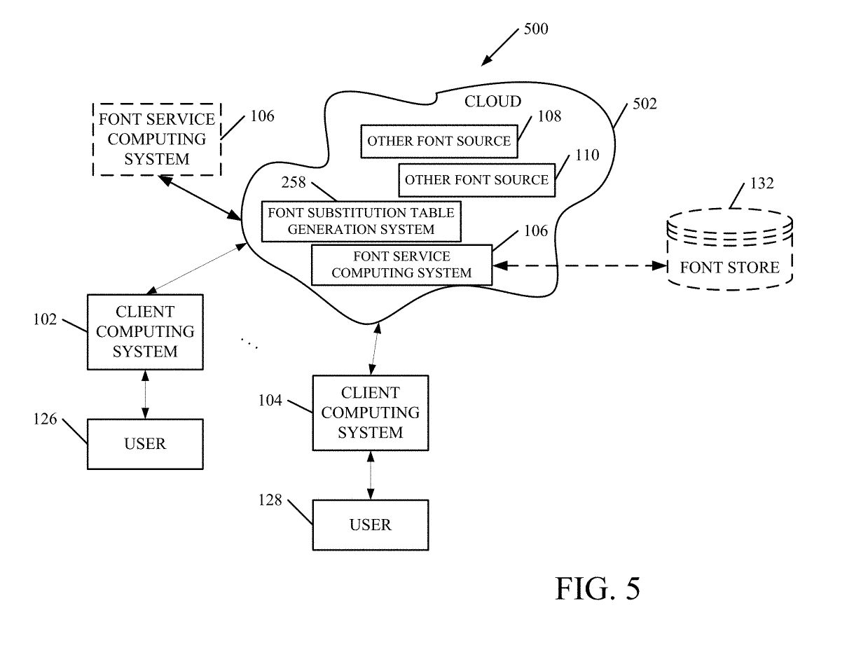

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various examples, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 5, some items are similar to those shown in FIG. 1 and they are similarly numbered. FIG. 5 specifically shows that systems 106 and 258, and other font sources 108 and 110 can be located in cloud 502 (which can be public, private, or a combination where portions are public while others are private). Therefore, users 126-128 can use user devices that includes client computing systems 102-104 to access those systems through cloud 502.

FIG. 5 also depicts another example of a cloud architecture. FIG. 5 shows that it is also contemplated that some elements can be disposed in cloud 502 while others are not. By way of example, data store 132 can be disposed outside of cloud 502, and accessed through cloud 502. In another example, font service computing system 106 is outside of cloud 502. Regardless of where they are located, they can be accessed directly by other devices or systems, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

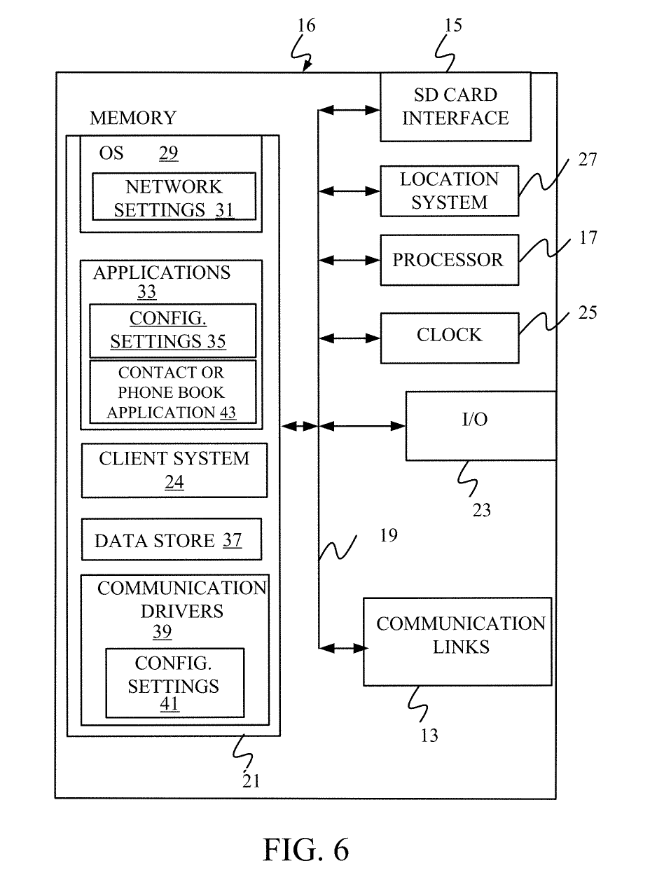

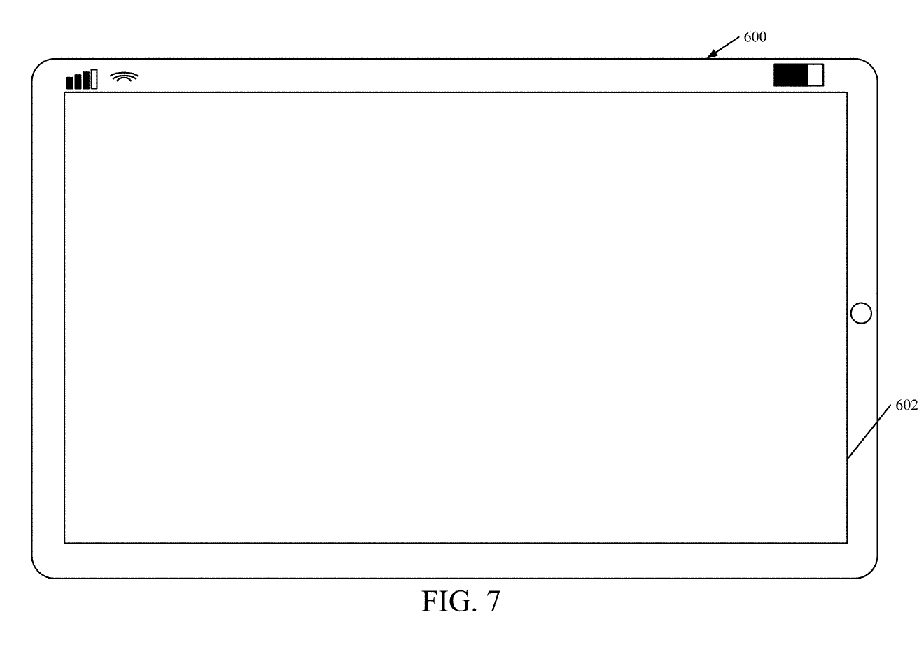

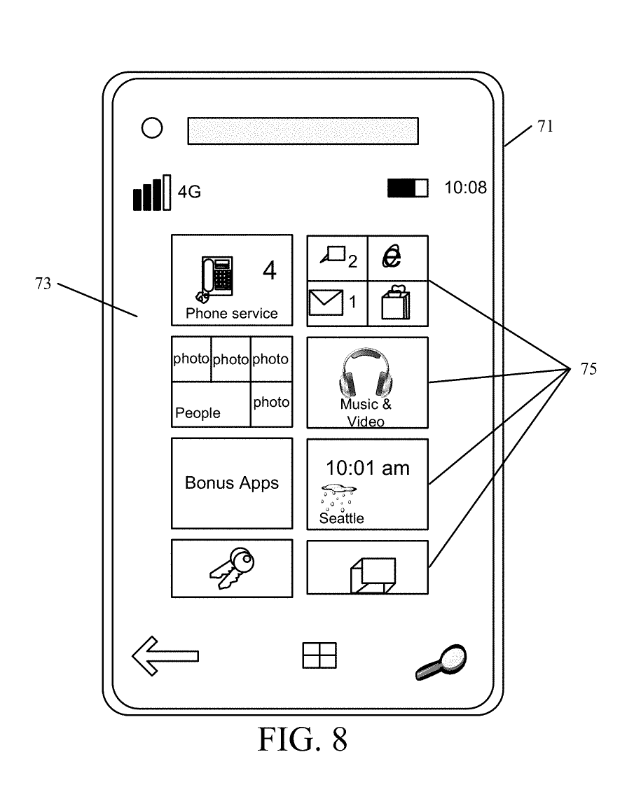

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors from previous Figures) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various business applications or embody parts or all of various systems. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

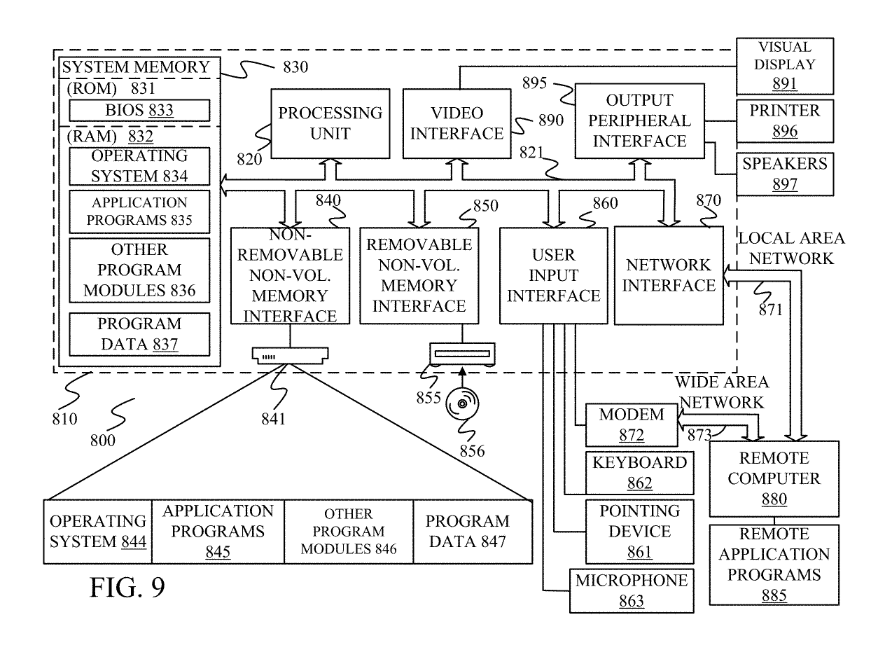

FIG. 9 is one example of a computing environment in which architecture 100, or parts of it, (for example) can be deployed. With reference to FIG. 9, an example system for implementing some embodiments includes a general-purpose computing device in the form of a computer 810. Components of computer 810 may include, but are not limited to, a processing unit 820 (which can comprise processors from previous Figures), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 9 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 9 illustrates remote application programs 885 as residing on remote computer 880. It will be appreciated that the network connections shown are exemplary and other means of establishing a communications link between the computers may be used.

Example 1 is a computing system, comprising:

an application component that runs an application that renders content;

tiered font identification logic that receives a requested font identifier, that identifies a font that is requested by the application component to render the content, and that identifies a substitute font identifier, the tiered font identification logic comprising:

first tier logic that accesses a predefined set of first tier mappings, that each map from an input font identifier to a substitute font identifier based on a first set of mapping criteria, to identify a matching first tier mapping that includes, as the identified substitute font identifier, a first tier substitute font identifier;

intermediate tier logic that, if no matching first tier mapping is found, accesses a predefined set of intermediate tier mappings, that each map from an input font attribute to a substitute font identifier based on a second set of mapping criteria, to identify a matching intermediate tier mapping that includes, as the identified substitute font identifier, an intermediate substitute font identifier; and

lowest tier logic that, if no matching intermediate tier mapping is found, identifies, as the substitute font identifier, a lowest tier substitute font identifier based on a set of lowest tier font identification criteria; and

font retrieval logic that obtains the identified substitute font identifier from the tiered font identification logic, retrieves a substitute font corresponding to the identified substitute font identifier, and provides the substitute font to the application component.

Example 2 is the computing system of any or all previous examples wherein the font retrieval logic comprises:

local font retrieval logic configured to access a local font store to determine whether the substitute font is in the local font store and, if so, retrieve the substitute font from the local font store.

Example 3 is the computing system of any or all previous examples wherein the font retrieval logic comprises:

font service accessing logic configured to, if the substitute font is not in the local font store, access a remote font service to retrieve the substitute font from the remote font service.

Example 4 is the computing system of any or all previous examples and further comprising:

temporary substitution logic configured to retrieve a temporary substitute font from the local font store and provide the temporary substitute font to the application component while the substitute font is retrieved from the remote font service.

Example 5 is the computing system of any or all previous examples and further comprising:

user notification logic that is configured to generate a user notification indicating that the temporary substitute font is being used.

Example 6 is the computing system of any or all previous examples wherein the user notification logic, when the substitute font is retrieved from the remote font service, generates the user notification with a user actuatable display element that is actuated to refresh the rendered content with the substitute font retrieved from the remote font service.

Example 7 is the computing system of any or all previous examples wherein the predefined set of first tier mappings each map from the input font identifier to the substitute font identifier based on manual inputs indicating a best substitute font for an input font.

Example 8 is the computing system of any or all previous examples wherein the intermediate tier mappings each map from a language of the input font to the substitute font identifier.

Example 9 is the computing system of any or all previous examples wherein the intermediate tier mappings each map from a script of the input font to the substitute font identifier.

Example 10 is the computing system of any or all previous examples wherein the intermediate tier mappings each map from a set of visual characteristics of the input font to the substitute font identifier.

Example 11 is the computing system of any or all previous examples wherein the lowest tier logic identifies a predefined default font identifier as the substitute font identifier.

Example 12 is the computing system of any or all previous examples wherein the tiered font identification logic identifies the substitute font identifier based on the requested font identifier and based on a characteristic of a rendering device on which the application component renders the content.

Example 13 is a computer implemented method, comprising:

receiving a requested font identifier, that identifies a font that is requested by an application component to render content;

identifying a substitute font identifier by:

accessing a predefined set of first tier mappings, that each map from an input font identifier to a substitute font identifier based on a first set of mapping criteria, to identify a matching first tier mapping that includes, as the identified substitute font identifier, a first tier substitute font identifier;

if no matching first tier mapping is found, accessing a predefined set of intermediate tier mappings, that each map from an input font attribute to a substitute font identifier based on a second set of mapping criteria, to identify a matching intermediate tier mapping that includes, as the identified substitute font identifier, an intermediate substitute font identifier; and

if no matching intermediate tier mapping is found, identifying, as the substitute font identifier, a lowest tier substitute font identifier based on a set of lowest tier font identification criteria;

retrieving a substitute font corresponding to the identified substitute font identifier; and providing the substitute font to the application component.

Example 14 is the computer implemented method of any or all previous examples wherein retrieving the substitute font comprises:

accessing a local font store to determine whether the substitute font is in the local font store and, if so, retrieving the substitute font from the local font store; and

if the substitute font is not in the local font store, accessing a remote font service to retrieve the substitute font from the remote font service.

Example 15 is the computer implemented method of any or all previous examples and further comprising:

if the substitute font is not in the local font store, then retrieving a temporary substitute font from the local font store; and

providing the temporary substitute font to the application component while the substitute font is retrieved from the remote font service.

Example 16 is the computer implemented method of any or all previous examples and further comprising:

generating a user notification indicating that the temporary substitute font is being used and including a user actuatable display element that is actuated to refresh the rendered content with the substitute font retrieved from the remote font service.

Example 17 is the computing system of any or all previous examples wherein identifying the substitute font identifier comprises:

identifying the substitute font identifier based on the requested font identifier and based on a characteristic of a rendering device on which the application component renders the content.

Example 18 is a computing system, comprising:

an application component that runs an application that renders content;

tiered font identification logic that receives a requested font identifier, that identifies a font that is requested by the application component to render the content, and that identifies a substitute font identifier, the tiered font identification logic comprising:

first tier logic that accesses a predefined set of first tier mappings, that each map from an input font identifier to a substitute font identifier based on a first set of mapping criteria, to identify a matching first tier mapping that includes, as the identified substitute font identifier, a first tier substitute font identifier;

intermediate tier logic that, if no matching first tier mapping is found, accesses a predefined set of intermediate tier mappings, that each map from an input font attribute to a substitute font identifier based on a second set of mapping criteria, to identify a matching intermediate tier mapping that includes, as the identified substitute font identifier, an intermediate substitute font identifier; and

lowest tier logic that, if no matching intermediate tier mapping is found, identifies, as the substitute font identifier, a lowest tier substitute font identifier based on a set of lowest tier font identification criteria;

local font retrieval logic that receives the substitute font identifier from the tiered font identification logic and is configured to access a local font store to determine whether the substitute font is in the local font store and, if so, retrieve the substitute font from the local font store and provide the substitute font to the application component; and

font service accessing logic configured to, if the substitute font is not in the local font store, access a remote font service to retrieve the substitute font from the remote font service.

Example 19 is the computing system of any or all previous examples and further comprising:

temporary substitution logic configured to retrieve a temporary substitute font from the local font store and provide the temporary substitute font to the application component while the substitute font is retrieved from the remote font service.

Example 20 is the computing system of any or all previous examples wherein the predefined set of first tier mappings each map from the input font identifier to the substitute font identifier based on manual inputs indicating a best substitute font for an input font.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
an application component that runs an application that renders content;
tiered font identification logic that receives a requested font identifier, that identifies a font that is requested by the application component to render the content, and that identifies a substitute font identifier, the tiered font identification logic comprising:
first tier logic that accesses a predefined set of first tier mappings, that each map from an input font identifier to a substitute font identifier based on a first set of mapping criteria, to identify a matching first tier mapping that includes, as the identified substitute font identifier, a first tier substitute font identifier;
intermediate tier logic that, if no matching first tier mapping is found, accesses a predefined set of intermediate tier mappings, that each map from an input font attribute to a substitute font identifier based on a second set of mapping criteria, to identify a matching intermediate tier mapping that includes, as the identified substitute font identifier, an intermediate substitute font identifier;
lowest tier logic that, if no matching intermediate tier mapping is found, identifies, as the substitute font identifier, a lowest tier substitute font identifier based on a set of lowest tier font identification criteria; and
font retrieval logic that obtains the identified substitute font identifier from the tiered font identification logic, retrieves a substitute font corresponding to the identified substitute font identifier, and provides the substitute font to the application component.

2. The computing system of claim 1 wherein the font retrieval logic comprises:
local font retrieval logic configured to access a local font store to determine whether the substitute font is in the local font store and, if so, retrieve the substitute font from the local font store.

3. The computing system of claim 2 wherein the font retrieval logic comprises:
font service accessing logic configured to, if the substitute font is not in the local font store, access a remote font service to retrieve the substitute font from the remote font service.

4. The computing system of claim 3 and further comprising:
temporary substitution logic configured to retrieve a temporary substitute font from the local font store and provide the temporary substitute font to the application component while the substitute font is retrieved from the remote font service.

5. The computing system of claim 4 and further comprising:
user notification logic that is configured to generate a user notification indicating that the temporary substitute font is being used.

6. The computing system of claim 5 wherein the user notification logic, when the substitute font is retrieved from the remote font service, generates the user notification with a user actuatable display element that is actuated to refresh the rendered content with the substitute font retrieved from the remote font service.

7. The computing system of claim 1 wherein the predefined set of first tier mappings each map from the input font identifier to the substitute font identifier based on manual inputs indicating a best substitute font for an input font.

8. The computing system of claim 1 wherein the intermediate tier mappings each map from a language of the input font to the substitute font identifier.

9. The computing system of claim 1 wherein the intermediate tier mappings each map from a script of the input font to the substitute font identifier.

10. The computing system of claim 1 wherein the intermediate tier mappings each map from a set of visual characteristics of the input font to the substitute font identifier.

11. The computing system of claim 1 wherein the lowest tier logic identifies a predefined default font identifier as the substitute font identifier.

12. The computing system of claim 1 wherein the tiered font identification logic identifies the substitute font identifier based on the requested font identifier and based on a characteristic of a rendering device on which the application component renders the content.

13. A computer implemented method, comprising:
receiving a requested font identifier, that identifies a font that is requested by an application component to render content;
identifying a substitute font identifier by:
accessing a predefined set of first tier mappings, that each map from an input font identifier to a substitute font identifier based on a first set of mapping criteria, to identify a matching first tier mapping that includes, as the identified substitute font identifier, a first tier substitute font identifier;
if no matching first tier mapping is found, accessing a predefined set of intermediate tier mappings, that each map from an input font attribute to a substitute font identifier based on a second set of mapping criteria, to identify a matching intermediate tier mapping that includes, as the identified substitute font identifier, an intermediate substitute font identifier; and
if no matching intermediate tier mapping is found, identifying, as the substitute font identifier, a lowest tier substitute font identifier based on a set of lowest tier font identification criteria;
retrieving a substitute font corresponding to the identified substitute font identifier; and
providing the substitute font to the application component.

14. The computer implemented method of claim 13 wherein retrieving the substitute font comprises:
accessing a local font store to determine whether the substitute font is in the local font store and, if so, retrieving the substitute font from the local font store; and
if the substitute font is not in the local font store, accessing a remote font service to retrieve the substitute font from the remote font service.

15. The computer implemented method of claim 14 and further comprising:
if the substitute font is not in the local font store, then retrieving a temporary substitute font from the local font store; and
providing the temporary substitute font to the application component while the substitute font is retrieved from the remote font service.

16. The computer implemented method of claim 15 and further comprising:
generating a user notification indicating that the temporary substitute font is being used and including a user actuatable display element that is actuated to refresh the rendered content with the substitute font retrieved from the remote font service.

17. The computing system of claim 13 wherein identifying the substitute font identifier comprises:
identifying the substitute font identifier based on the requested font identifier and based on a characteristic of a rendering device on which the application component renders the content.

18. A computing system, comprising:
an application component that runs an application that renders content;
tiered font identification logic that receives a requested font identifier, that identifies a font that is requested by the application component to render the content, and that identifies a substitute font identifier, the tiered font identification logic comprising:
first tier logic that accesses a predefined set of first tier mappings, that each map from an input font identifier to a substitute font identifier based on a first set of mapping criteria, to identify a matching first tier mapping that includes, as the identified substitute font identifier, a first tier substitute font identifier;
intermediate tier logic that, if no matching first tier mapping is found, accesses a predefined set of intermediate tier mappings, that each map from an input font attribute to a substitute font identifier based on a second set of mapping criteria, to identify a matching intermediate tier mapping that includes, as the identified substitute font identifier, an intermediate substitute font identifier; and
lowest tier logic that, if no matching intermediate tier mapping is found, identifies, as the substitute font identifier, a lowest tier substitute font identifier based on a set of lowest tier font identification criteria;
local font retrieval logic that receives the substitute font identifier from the tiered font identification logic and is configured to access a local font store to determine whether the substitute font is in the local font store and, if so, retrieve the substitute font from the local font store and provide the substitute font to the application component; and
font service accessing logic configured to, if the substitute font is not in the local font store, access a remote font service to retrieve the substitute font from the remote font service.

19. The computing system of claim 18 and further comprising:
temporary substitution logic configured to retrieve a temporary substitute font from the local font store and provide the temporary substitute font to the application component while the substitute font is retrieved from the remote font service.

20. The computing system of claim 18 wherein the predefined set of first tier mappings each map from the input font identifier to the substitute font identifier based on manual inputs indicating a best substitute font for an input font.
